(19) United States
(12) Patent Application Publication
(10) Pub. No.: US 2026/0030028 A1
(43) Pub. Date: Jan. 29, 2026

(54) BRANCH PREDICTION CORRECTION BASED ON NONUSE OF RELEVANT PREDICTION STRUCTURE

(71) Applicant: International Business Machines Corporation, Armonk, NY (US)

(72) Inventors: James Raymond Cuffney, POUGHKEEPSIE, NY (US); Edward Thomas Malley, Eastchester, NY (US); Adam Benjamin Collura, Hopewell Junction, NY (US); Brian Robert Prasky, Campbell Hall, NY (US); James Bonanno, Liberty Hill, TX (US)

(73) Assignee: International Business Machines Corporation, Armonk, NY (US)

(21) Appl. No.: 18/783,621

(22) Filed: Jul. 25, 2024

(51) Int. Cl. G06F 9/38; G06F 9/30

(52) U.S. Cl. CPC G06F 9/3844; G06F 1/3287; G06F 9/3806; G06F 9/3848

(57) ABSTRACT

A branch prediction unit of the processor powers-up and accesses only a subset of a plurality of prediction structures to obtain a first set of branch prediction information for a conditional branch. During the access, at least one of the plurality of prediction structures remains powered-down. The branch prediction unit thereafter determines whether all of the plurality of prediction structures having branch prediction information relevant to the conditional branch were accessed. Based on a determination that fewer than all of the plurality of prediction structures having branch prediction information relevant to the conditional branch were accessed, the branch prediction unit refrains from outputting a branch prediction based on the first set of branch prediction information, powers-up and accesses a greater number of the plurality of prediction structures to obtain a second set of branch prediction information, and outputs a branch prediction based on the second set of branch prediction information.

### BACKGROUND OF THE INVENTION

The present invention relates in general to data processing, and more particularly, to branch prediction in a processor.

A conventional processor may include an instruction fetch unit for fetching instructions to be executed, an instruction sequencing unit for ordering sequential instructions among the fetched instruction for execution, and one or more execution units for executing the sequential instructions. A conventional processor may additionally include a branch processing unit for processing branch instructions that redirect the path of sequential execution.

Some branch processing units include a branch prediction unit that predicts the outcomes of conditional branch instructions in advance of the availability of all conditions needed to determine the outcome of the conditional branch instructions with certainty. The branch predictions generated by the branch prediction unit are utilized to redirect fetching by the instruction fetch unit in order to reduce instruction fetch latency. In the event of branch misprediction, the processor discards fetched instructions in the incorrect execution path and any associated processing results, and the instruction fetch unit redirects fetching to the correct path of execution.

The present application appreciates that branch misprediction is costly in terms of both the instruction fetch latency incurred and the power dissipated by the branch misprediction and the processing of instructions in the mispredicted path. Consequently, the present application recognizes that it would be useful and desirable to improve the branch prediction accuracy of a branch processing unit while also promoting low power operation.

### SUMMARY OF THE INVENTION

In at least one embodiment, a branch prediction unit of the processor powers-up and accesses only a subset of a plurality of prediction structures to obtain a first set of branch prediction information for a conditional branch. During the access, at least one of the plurality of prediction structures remains powered-down. The branch prediction unit thereafter determines whether all of the plurality of prediction structures having branch prediction information relevant to the conditional branch were accessed. Based on a determination that fewer than all of the plurality of prediction structures having branch prediction information relevant to the conditional branch were accessed, the branch prediction unit refrains from outputting a branch prediction based on the first set of branch prediction information, powers-up and accesses a greater number of the plurality of prediction structures to obtain a second set of branch prediction information, and outputs a branch prediction based on the second set of branch prediction information.

### BRIEF DESCRIPTION OF THE DRAWINGS

FIG. 1 is a high-level block diagram of an exemplary data processing system including a processor in accordance with one or more embodiments;

FIG. 2 is a high-level block diagram of an exemplary processor core in accordance with one or more embodiments;

FIG. 3 is a more detailed block diagram of various circuitry in an exemplary branch processing unit in accordance with one or more embodiments;

FIG. 4 depicts the buffering of branch instructions in a branch target buffer (BTB) in accordance with one embodiment;

FIG. 5 is a data flow diagram of a branch prediction unit in accordance with one or more embodiments;

FIG. 6 is a high-level logical flowchart of an exemplary process of branch prediction in accordance with one or more embodiments;

FIG. 7 is a high-level logical flowchart of an exemplary process of managing the powering-down of branch prediction structures in accordance with one or more embodiments; and

FIG. 8 is a design flow in accordance with at least one embodiment.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

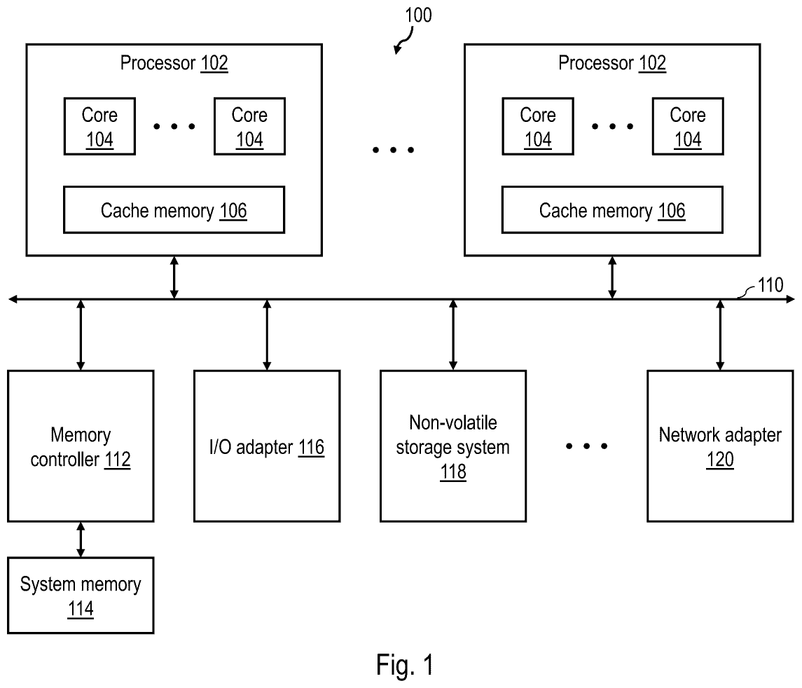

With reference now to the figures and in particular with reference to FIG. 1, there is illustrated a high-level block diagram of an exemplary data processing system 100 in accordance with one or more embodiments. In some embodiments, data processing system 100 can be, for example, a mainframe computer system, a server computer system, a laptop or desktop personal computer system, a mobile computing device (such as a smartphone or tablet), an edge computing device (e.g., an Internet-of-things (IOT) sensor), or an embedded processor system.

As shown, data processing system 100 includes one or more processors 102 for processing instructions and data. Each processor 102 may be realized as a respective integrated circuit having a semiconductor substrate in which integrated circuitry is formed, as is known in the art. In at least some embodiments, processors 102 can generally implement any one of a number of commercially available processor architectures, for example, z/Architecture, POWER, RISC-V, ARM, Intel x86, NVidia, Apple silicon, etc. In the depicted example, each processor 102 includes one or more processor cores 104 for executing one or more simultaneous threads of execution and cache memory 106 providing processor cores 104 low latency access to instructions and operands likely to be read and/or written. Processors 102 are coupled for communication by a system interconnect 110, which in various implementations may include one or more buses, switches, bridges, and/or hybrid interconnects.

Data processing system 100 may additionally include a number of other components coupled to system interconnect 110. These components can include, for example, a memory controller 112 that controls access by processors 102 and other components of data processing system 100 to system memory 114. In addition, data processing system 100 may include an input/output (I/O) adapter 116 for coupling one or I/O devices to system interconnect 110, a non-volatile storage system 118, and a network adapter 120 for coupling data processing system 100 to a communication network (e.g., a wired or wireless local area network and/or the Internet).

Those skilled in the art will additionally appreciate that data processing system 100 shown in FIG. 1 can include many additional non-illustrated components. Because such additional components are not necessary for an understanding of the described embodiments, they are not illustrated in FIG. 1 or discussed further herein. It should also be understood, however, that the enhancements described herein are applicable to data processing systems and processors of diverse architectures and are in no way limited to the generalized data processing system architecture illustrated in FIG. 1.

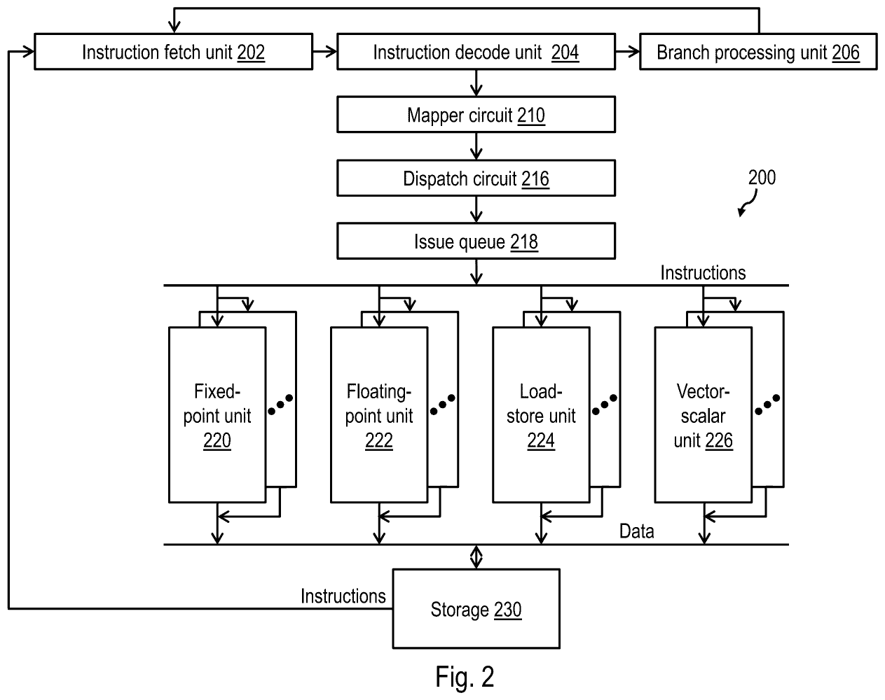

Referring now to FIG. 2, there is depicted a high-level block diagram of an exemplary processor core 200 in accordance with one or more embodiments. Processor core 200 may be utilized to implement any of processor cores 104 of FIG. 1.

In the depicted example, processor core 200 includes an instruction fetch unit 202 for fetching architected instructions within one or more threads of execution from storage 230 (which may include, for example, cache memories 106 and/or system memory 114 from FIG. 1). In a typical implementation, each architected instruction has a format defined by the instruction set architecture of processor core 200 and includes at least an operation code (opcode) field specifying an operation (e.g., fixed-point or floating-point arithmetic operation, vector operation, matrix operation, logical operation, branch operation, memory access operation, cryptographic operation, etc.) to be performed by processor core 200. Certain architected instructions may additionally include one or more operand fields directly specifying operands or implicitly or explicitly referencing one or more source registers storing source operand(s) to be utilized in the execution of the instruction and one or more target registers for storing destination operand(s) generated by execution of the architected instruction. Instruction decode unit 204, which in some embodiments may be merged with instruction fetch unit 202, decodes the architected instructions retrieved from storage 230 by instruction fetch unit 202 and forwards branch instructions that control the flow of execution to branch processing unit 206. In preferred embodiments, the processing of branch instructions performed by branch processing unit 206 may include speculating the outcome of conditional branch instructions. The results of branch processing (both speculative and non-speculative) by branch processing unit 206 may, in turn, be utilized to redirect one or more streams of instruction fetching by instruction fetch unit 202.

Those skilled in the art will appreciate that in certain processor architectures, individual architected instructions can be “cracked” or converted into multiple distinctly executable microcode operations (sometimes referred to as “micro ops”). Such instruction cracking may be performed by instruction decode unit 204 or elsewhere in the instruction pipeline(s) of processor core 200. Because the distinction between microcode operations and architected instructions is not relevant to the described embodiments, the generic term “instruction” is utilized hereafter to refer to architected instructions and/or internal microcode operations.

Instruction decode unit 204 forwards instructions that are not branch instructions (often referred to as “sequential instructions”) to mapper circuit 210. Mapper circuit 210 is responsible for the assignment of physical registers within the register files of processor core 200 to instructions as needed to support instruction execution. Mapper circuit 210 preferably implements register renaming. Thus, for at least some classes of instructions, mapper circuit 210 establishes transient mappings between a set of logical (or architected) registers referenced by the instructions and a larger set of physical registers within the register files of processor core 200. As a result, processor core 200 can avoid unnecessary serialization of instructions that are not data dependent, as might otherwise occur due to the reuse of the limited set of architected registers by instructions proximate in program order.

Still referring to FIG. 2, processor core 200 additionally includes a dispatch circuit 216 configured to ensure that any data dependencies (e.g., RAW (Read after Write), WAR (Write after Read), or WAW (Write after Write)) between instructions are observed and to dispatch sequential instructions as they become ready for execution. Instructions dispatched by dispatch circuit 216 are temporarily buffered in an issue queue 218 until the execution units of processor core 200 have resources available to execute the dispatched instructions. As the appropriate execution resources become available, a control circuit within issue queue 218 issues instructions from issue queue 218 to the execution units of processor core 200 opportunistically and possibly out-of-order with respect to the original program order of the instructions.

In the depicted example, processor core 200 includes several different types of execution units for executing respective different classes of instructions. In this example, the execution units include one or more fixed-point units 220 for executing instructions that access fixed-point operands, one or more floating-point units 222 for executing instructions that access floating-point operands, one or more load-store units 224 for loading data from and storing data to storage 230, and one or more vector-scalar units 226 for executing instructions that access vector and/or scalar operands. In a typical embodiment, each execution unit is implemented as a multi-stage pipeline in which multiple instructions can be simultaneously processed at different stages of execution. Each execution unit preferably includes or is coupled to access at least one register file including a plurality of physical registers for temporarily buffering operands accessed in or generated by instruction execution.

Those skilled in the art will appreciate that processor core 200 may include additional unillustrated components and/or circuits. Because these additional components and/or circuits are not necessary for an understanding of the described embodiments, they are not illustrated in FIG. 2 or discussed further herein.

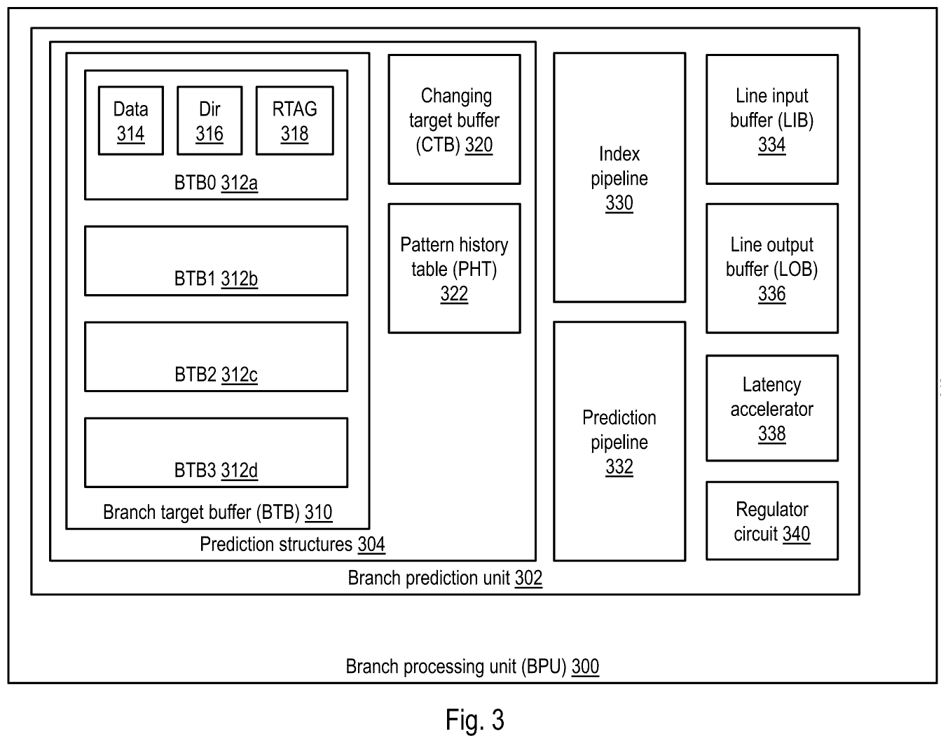

With reference now to FIG. 3, there is illustrated a more detailed block diagram of a branch processing unit 300 in accordance with one or more embodiments. Branch processing unit 300 is one example of a circuit that can be utilized to implement branch processing unit 206 of FIG. 2.

BPU 300 includes a branch prediction unit 302 that predicts the behavior of conditional branch instructions, including, for example, the direction and target addresses of branch instructions. Branch prediction unit 302 in turn includes a number of prediction structures 304 (e.g., arrays) for storing branch prediction information, as discussed in greater detail below. In preferred embodiments, branch prediction unit 302 is configured to selectively power-down various one(s) of prediction structures 304 during determination of at least some branch predictions in order to reduce the overall power dissipation of branch prediction unit 302. In at least some embodiments, entries in prediction structures 304 that may be relevant to the prediction of conditional branch instructions are accessed utilizing indices derived from the instruction addresses of the conditional branch instructions.

In some examples, branch prediction unit 302 additionally includes an index pipeline 330 in which indices of instruction addresses of conditional branch instructions are processed and a prediction pipeline 332 in which branch prediction information accessed from prediction structures 304 is evaluated to determine branch predictions (e.g., branch directions and branch target addresses). In the illustrated embodiment, branch prediction unit 302 also includes a line input buffer (LIB) 334 for temporarily buffering branch-related information utilized to access prediction structures 304 (e.g., indices derived from branch instruction addresses) and a line output buffer (LOB) 336 for temporarily buffering the outputs of index pipeline 330.

Branch prediction 302 may additionally include a latency accelerator 338, which can be implemented as an array of entries configured to store indices of prediction structures 304 and power mode field that can be utilized by branch prediction unit 302 to predict the appropriate power state(s) of various ones of prediction structures 304 during a prediction access. Latency accelerator 338 can accelerate future branch predictions by repetitively populating LIB 334 with a next index to be utilized to access prediction structures 304 based on a prior index that was utilized to access prediction structures 304.

In the depicted example, branch prediction unit 302 further includes a regulator circuit 340 configured to control the powering-down of various one(s) of prediction structures 304 by branch prediction unit 302. In one embodiment, regulator circuit 340 can be implemented as a small array of entries in which each entry maintains of a value (e.g., a counter value) representing whether the power mode field for conditional branch instructions (e.g., stored in entries in latency accelerator 338) should be utilized to control the power states of prediction structures 304 or whether branch prediction unit 302 should power up additional (e.g., all) prediction structures 304 regardless of the power mode field. In one exemplary embodiment in which branch instructions are associated with 63-bit virtual addresses including bits 0:62, entries in regulator circuit 340 can be indexed by virtual address bits 53:56.

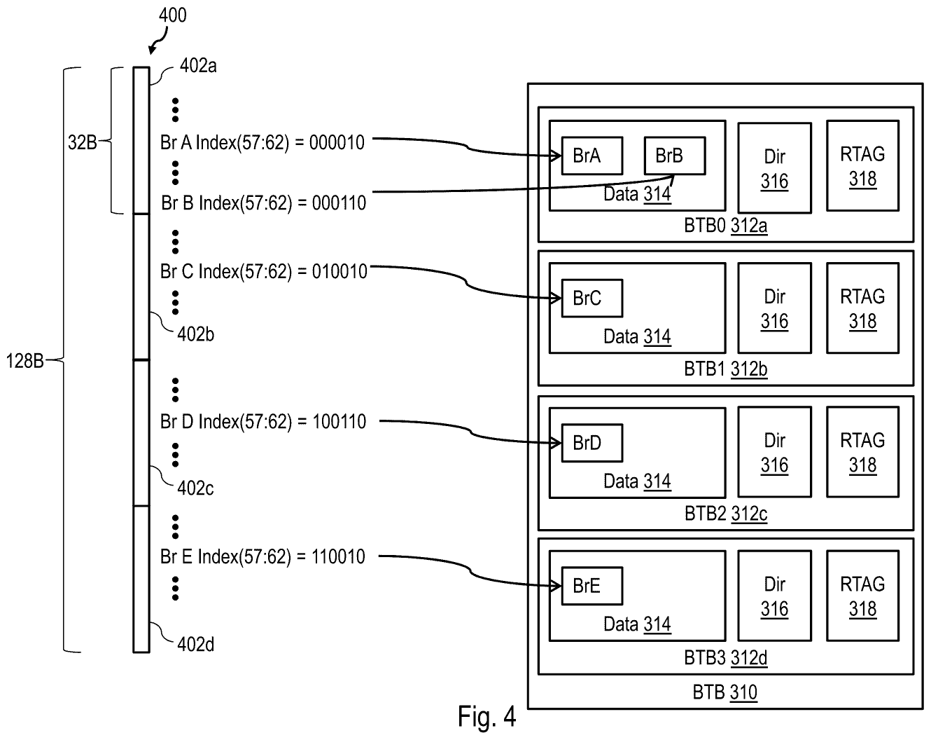

Still referring to FIG. 3, in the depicted embodiment, prediction structures 304 include one or more instances of a branch target buffer (BTB) 310, of which only a single instance is explicitly illustrated to avoid unnecessarily obscuring the details thereof. In one exemplary implementation, BTB 310 includes multiple, in this example, four, subarrays BTB0 312a-BTB3 312d. In the depicted example, each subarray 312 of BTB 310 in turn includes a directory array 316 for storing information used to determine if there is a hit for a given branch instruction index and a data array 314 and register tag (RTAG) array 318 configured to store branch prediction information utilized to make branch predictions. As discussed further below with reference to FIG. 4, different ones of subarrays 312 can be utilized to branch prediction information for different branch instructions, for example, based on differing values of an index portion of branch instruction addresses.

Prediction structures 304 may include additional auxiliary prediction structures, such as a changing target buffer (CTB) 320 and a pattern history table (PHT) 322. In the illustrated example, CTB 320 is utilized to buffer alternative branch target addresses for branch instructions, like those terminating subroutines, for which multiple branch target addresses are possible. In the illustrated example, PHT 322 can be utilized to buffer branch target addresses for branch instructions that have multiple possible different directions (e.g., branch instructions that implement IF/THEN/ELSE constructs). As will be appreciated by those skilled in the art, in a typical case, branch prediction unit 302 may not require access to one or more of subarrays 312 or to one or both of auxiliary prediction structures 320, 322 in order to determine a given branch prediction. Consequently, in many cases, branch prediction unit 302 can power-down the prediction structure(s) 304 (or portions of the prediction structure(s) that will not be used) in order to reduce the power dissipation associated with branch prediction.

Referring now to FIG. 4, the buffering of branch instructions in a branch target buffer (BTB) 310 in accordance with one embodiment is now depicted. On the left, FIG. 4 depicts an exemplary 128-byte instruction cacheline 400, which includes four 32-byte segments 402a-402d. Instruction fetch unit 202 may access instruction cacheline 400 from storage 230 as part of an instruction stream to be processed in a processor core 200. In the depicted example, segment 402a contains, among other instructions, branch instructions Br A and Br B; segment 402b contains, among other instructions, branch instruction Br C; segment 402c contains, among other instructions, branch instruction Br D; and segment 402d contains, among other instructions, branch instruction Br E. As indicated, branch prediction unit 302 may install branch instructions in subarrays 312a-312d of BTB 310 based upon the segment(s) 402 of an instruction cacheline 400 in which the branch instructions are disposed. Thus, for example, branch prediction unit 302 may install branch instructions Br A and Br B in BTB0 312a and may install branch instructions Br C, Br D, and Br E in subarrays 312b-312d, respectively. In this example, instructions are referenced by 63-bit virtual addresses including bits 0:62. In one embodiment, branch prediction unit 302 utilizes bits 48:56 of the virtual address to index the entries of subarrays 312 and uses bits 57:62 of the virtual address to uniquely identify branch instructions.

Consider now the following exemplary pseudocode snippet, which can fit within a single 128-byte instruction cacheline 400:

```
...
A = 0
WHILE (A < 100)
{
  ...
  IF (A > 50)
    [Code including additional branches that do not all fit in one BTB
    subarray]
    [Code including at least one multi-target branch]
  }
  ...
  INC A
  }
```

In this example, the IF statement (i.e., IF (A>50)) is as a conditional branch point that encloses additional conditional branches. Among these additional conditional branches is a multi-target branch, which branch prediction unit 302 can predict by reference to CTB 320. The end of the WHILE loop (which tests whether WHILE A<100 returns a true result) is also a conditional branch point. It should be noted that, in this example, some branches are not be encountered until certain conditions are met. For example, the conditional branches inside the IF statement are only encountered if the test A>50 returns a true result.

As this pseudocode snippet begins execution, only the conditional branches represented by the IF statement and the WHILE loop are encountered. The first time these conditional branches are encountered, branch prediction unit 302 places the conditional branches in one of subarrays 312 of BTB 310 (e.g., BTB0 312a). Until these conditional branches exhibit different behavior (e.g., when A>50 or A=100), branch prediction unit 302 need not consult auxiliary prediction structures (e.g., CTB 320 and PHT 322) or the other three subarrays 312 (BTB1 312b to BTB3 312d) during the branch prediction process.

Once A>50, the IF statement becomes TRUE, and the behavior of the conditional branch associated with the IF statement is different than during prior passes through the WHILE loop. In addition, when the IF statement is TRUE, branch prediction unit 302 encounters the additional conditional branches enclosed by the IF statement for the first time. As the execution pipeline for these conditional branches reaches completion, branch prediction unit 302 also installs these additional conditional branches in the appropriate prediction structures 304. For example, branch prediction unit 302 may install one or more of the additional conditional branches in one or more additional subarrays 312 and one or more of auxiliary prediction structures 320, 322.

In preferred embodiments, branch prediction unit 302 tracks which prediction structures 304 have been relevant to determining predictions for a given index for a branch instruction address. Tracking the relevance of prediction structures in this manner enables branch prediction unit 302 to reduce power dissipation by powering up only a subset of prediction structures 304 in at least some cases in which fewer than all prediction structures 304 are relevant to a given prediction. In the example of the above pseudocode, branch prediction unit 302 can power up only a single subarray 312 (e.g., BTB0 312a) rather than all of prediction structure 304 until the test A>50 returns TRUE.

The present application appreciates that in some branch prediction scenarios, branch prediction unit 302 may power-down one or more prediction structure(s) 304 that are, in fact, relevant to a correct branch prediction. Rather than simply allow a misprediction to be made on the contents of an insufficiently large subset of prediction structures 304, branch prediction unit 302 preferably corrects the power-down behavior of prediction structures 304 before an incorrect branch prediction is utilized to redirect the fetching of instruction fetch unit 202. In some embodiments, this correction of the power-down behavior results in a reprediction of a branch instruction. For example, in processing of the foregoing pseudocode, when branch prediction unit 302 encounters the additional conditional branches enclosed within the IF statement, the prediction structures 304 relevant to the prediction of the additional conditional branches expand to include additional subarrays 312 and auxiliary prediction structures 320, 322. By dynamically correcting the power-down behavior of prediction structures 304 and avoiding mispredictions due to incorrect power-down behavior, overall prediction accuracy is improved while still supporting, when possible, low power operation of prediction structures 304.

The present application additionally appreciates that it is desirable for branch prediction unit 302 to be configured to temporarily disable powering down of prediction structures 304 after a “prediction structure subset changing (PSSC) event” occurs. For purposes of the present application, a PSSC event refers to any event that changes the subset of prediction structures 304 relevant to prediction of the conditional branches for a given instruction cacheline 400. For example, in processing the foregoing pseudocode, branch prediction unit 302 detects a PSSC event when it encounters the additional conditional branches inside the IF statement. By temporarily disabling the power-down of prediction structures 304 in response to detection of a PSSC event, branch prediction unit 302 can maintain high prediction accuracy while learning the behaviors of the additional conditional branches.

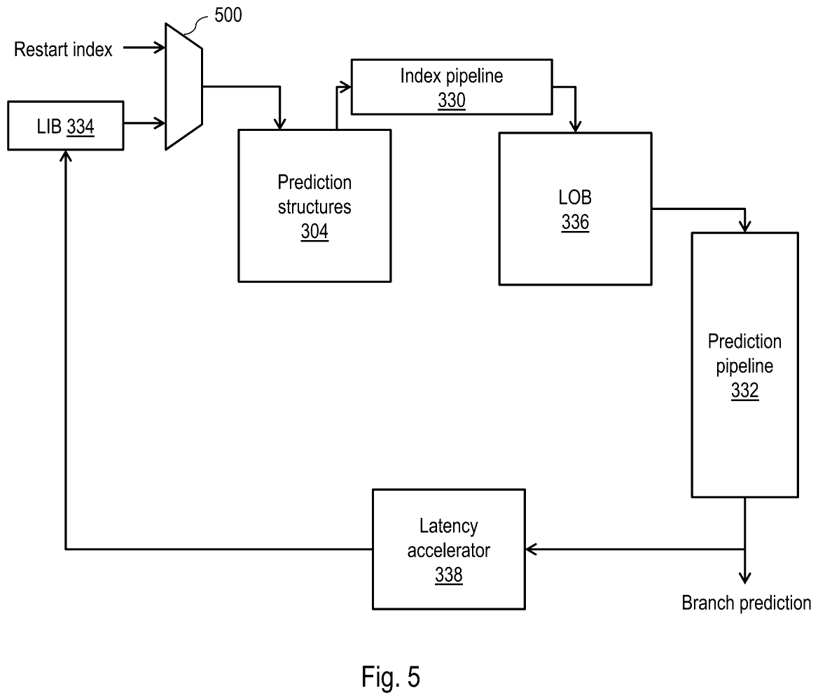

With reference now to FIG. 5, there is illustrated a data flow diagram of a branch prediction unit 302 in accordance with one or more embodiments. In this example, a selection circuit 500 (e.g., a multiplexer) selects between a branch instruction index supplied by LIB 334 and a restart index employed when index pipeline 330 is initially started or restarted (e.g., after a flush). Each of these indices preferably is accompanied by a respective power mode field indicating the set of prediction structures 304 is to be powered-down for the branch prediction access for the index. In a preferred embodiment, the power mode field associated with the restart index indicates that no prediction structures 304 are to be powered-down and that all prediction structures 304 are to be powered-up.

Based on the index (and associated power mode field) selected by selection circuit 500, branch prediction unit 302 controls the power state of each of prediction structures 304 and accesses an entry in each of the powered-up prediction structure(s) 304 utilizing the selected index. The branch prediction information read from the entries in the powered-up prediction structure(s) 304 is processed in index pipeline 330 to determine whether or not the index hit in any of the powered-up prediction structure(s) 304. If so, branch prediction unit 302 stores in an entry of LOB 336: (1) the branch prediction information read from the entry for which a hit occurred and (2) the power mode field used for the access (which passes through index pipeline 330 and is thus available to prediction pipeline 332). Once prediction pipeline 332 is ready to process a next entry in LOB 336, the entry is read out from LOB 336 and processed through prediction pipeline 332 to generate a branch prediction (e.g., branch direction and target address).

In the depicted example, latency accelerator 338 stores a plurality of entries, each associating an input index with an output index and its associated power mode field. Latency accelerator 338 takes an input the index of the branch instruction for which a prediction is output by prediction pipeline 332 and outputs the associated output index and power mode field, which are stored in LIB 334. As noted above, the index and associated power mode field inserted into LIB 334 can then be selected by selection circuit 500 to control the power states of prediction structures 304 and to initiate a subsequent read of the powered-up prediction structures 304. Thus, the data flow depicted in FIG. 5 is iterative, and as the power mode fields change for various indices, the updated power mode fields pass through latency accelerator 338 and into LIB 334 for use in making subsequent predictions.

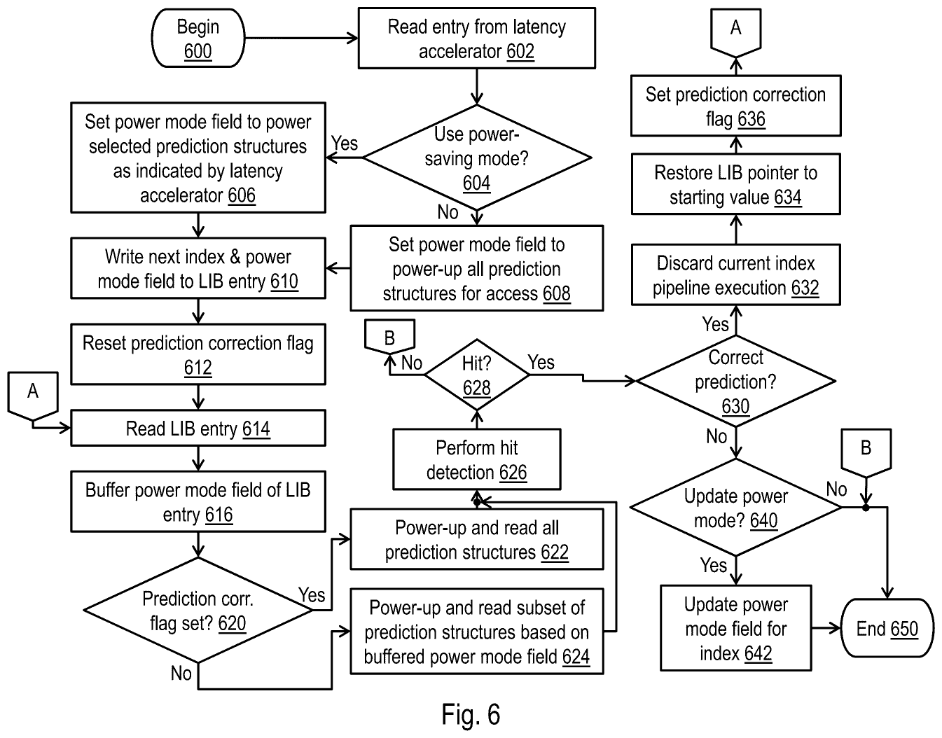

Referring now to FIG. 6, there is depicted a high-level logical flowchart of an exemplary process of branch prediction in accordance with one or more embodiments.

The process of FIG. 6 begins at block 600 and then proceeds to block 602, which illustrates branch prediction unit 302 reading an entry from latency accelerator 338 based on the index associated with the immediately previous branch prediction output from prediction pipeline 332. As noted above, the entry read from latency accelerator 338 preferably includes a next index to be utilized to access prediction structures 304 and an associated power mode field that predicts power states of prediction structures 304. At block 604, branch prediction unit 302 determines whether or not to employ, for the access to prediction structures 304 utilizing the next index read from latency accelerator 338, a power-saving mode in which the contents of the power mode field can be utilized to selectively power-down one or more of prediction structures 304. In one embodiment, branch prediction unit 302 makes the determination depicted at block 604 based on the counter value maintained in the entry in regulator circuit 340 associated with the next index read from latency accelerator 338. For example, in one implementation, a counter value of zero indicates to branch prediction unit 302 that the power mode field associated with the next index is to be utilized; a non-zero counter value indicates that all prediction structures 304 are to be powered-up for the access to prediction structures 304 utilizing the next index regardless of its associated power mode field.

Based on a determination at block 604 that the power-saving mode is to be utilized, branch prediction unit 302 sets a power mode field to power-up only selected prediction structure(s) 304 (generally fewer than all) as indicated by the entry read from latency accelerator 338. If on the other hand, branch prediction unit 302 determines at block 604 not to employ the power-saving mode, branch prediction unit 302 sets the power mode field to power-up all prediction structures 304 for the access to prediction structures 304 utilizing the next index. Following either block 606 or block 608, branch prediction unit 302 writes to an entry in LIB 334 the next index read from latency accelerator 338 and the power mode field set at either block 606 or block 608 (block 610).

At block 612, branch prediction unit 302 resets (e.g., to 0b0) a prediction correction flag indicating whether branch prediction unit 302 is to repredict a conditional branch utilizing additional branch information from one or more previously powered-down prediction structure(s) 304. Branch prediction unit 302 additionally reads a next entry from LIB 334, for example, the entry written at block 610 (block 614), and buffers the power mode field read from the entry in LIB 334 (block 616). At block 620, branch prediction unit 302 determines whether the prediction correction flag is set (e.g., to 0b1). In response to a determination at block 620 that the prediction correction flag is set, branch prediction unit 302 powers-up and accesses branch prediction information from all prediction structures 304 utilizing the index read from LIB 614 (block 622). If, on the other hand, branch prediction unit 302 determines at block 620 that the prediction correction flag is reset, branch prediction unit 302 powers-up and accesses, utilizing the index read from LIB 614, branch prediction information from the subset of prediction structures 304 indicated by the buffered power mode field (block 624). In at least some embodiments, directories 316 of subarrays 312 are powered-up for all prediction accesses regardless of the content of the power mode field because the contents of the entries of directories 316 are required for hit detection; however, the data array(s) 314 and RTAG arrays 318 of one or more of subarrays 312 can be selectively powered-down based on the content of the power mode field. Those skilled in the art will appreciate that in a typical implementation data arrays 314 and RTAG arrays 318 are significantly larger in size than directories 316 and therefore consume the majority of the power dissipated in accessing BTB 310.

Once a set of branch prediction information is read from the powered-up prediction structure(s) 304 at either block 622 or block 624, branch prediction unit 302 determines whether the index hit in the powered-up prediction structure(s) 304 (block 626). If not, the process passes through page connector B and terminates at block 650. In this case, because branch prediction unit 302 does not have branch prediction information relevant to the branch available, BPU 300 processes the branch non-speculatively. However, in response to a determination at block 626 that the index hit in the powered-up prediction structure(s) 304, the process passes to block 630. At block 630, branch prediction unit 302 determines in index pipeline 330 whether or not correction of the prediction of the current branch is to be performed, for example, based on various checks that determine whether all prediction structures 304 having relevant branch prediction information were powered-up during the access made at block 622 or block 624. One example of the checks performed at block 630 is a check that the data array 314 associated with each directory 316 for which a hit was detected was powered-up during the access. If all of the checks made at block 630 pass, the process passes to block 640, which is described below. If any of the checks performed at block 630 fails, then branch prediction unit 302 determines at block 630 that correction of the prediction is needed and discards the execution results within index pipeline 330 (block 632). Thus, branch prediction unit 302 refrains from outputting a branch prediction based on an incomplete set of branch prediction information. In addition, branch prediction unit 302 reverts a pointer for LIB 334 to its starting value so that the entry previously accessed at block 614 will again be accessed (block 634) and sets the prediction correction flag (block 636). The process then returns through page connector A to block 614.

On a second pass, based on a determination at block 620 that the prediction correction flag is set, branch prediction unit 302 powers-up and accesses all prediction structures 304 at block 622 utilizing the index accessed from LIB 334. Reading all prediction structures 304 at block 622 guarantees that the checks made at block 630 will succeed on the second pass and that branch prediction unit 302 will make a negative determination at block 630. In response to a negative determination at block 630, the process proceeds to block 640, which illustrates branch prediction unit 302 determining whether or not to update the power mode field for the current index. If so, branch prediction unit 302 updates, in latency accelerator 338, the power mode field for the current index (block 642). Thus, branch prediction unit 302 is configured to correct outdated power mode information for prediction structures 304 based on only a single reprediction.

In one embodiment, branch prediction unit 302 corrects the power mode field at block 642 by writing LOB 336 with the hit detection information accessed from prediction structures 304 and the power mode field utilized to access prediction structures 304. Once LOB 336 is read and the prediction pipeline 332 completes, branch prediction unit 302 compares the power mode field with the hit detection information. If the power mode field does not match the hit detection information, then branch prediction unit 302 updates latency accelerator 338 with an updated power mode field reflecting all prediction structures 304 in which a hit was detected in conjunction with the write performed at the end of the prediction pipeline 332. As one example, assume that the power mode field for a given index indicates that subarrays BTB0 312a and BTB1 312b are to be powered up and all other prediction structures 304 are to be powered down. If branch prediction unit 302 determines by the processing in index pipeline 330 that the index only hit in subarray BTB1 312a, branch prediction unit 302 will detect a mismatch between the power mode field and the hit detection information. Consequently, at block 642, branch prediction unit 302 will update the power mode field for the index in latency accelerator 338 to indicate to only power-up subarray BTB1 312a.

Following either a negative determination at block 640 or block 642, the process of FIG. 6 ends at block 650.

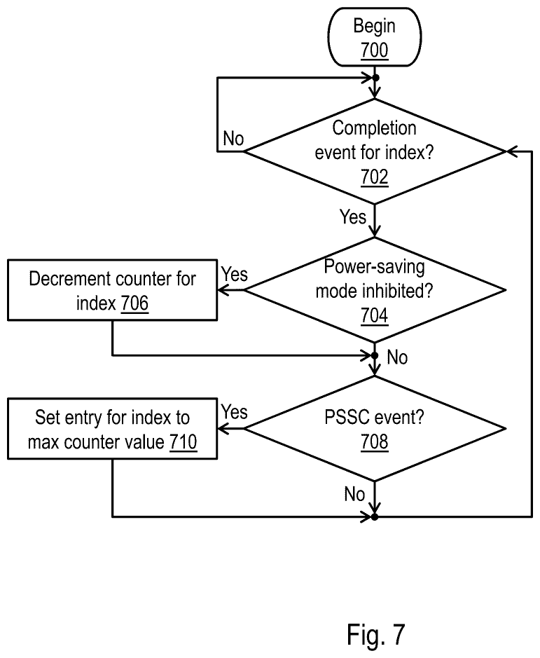

With reference now to FIG. 7, there is illustrated a high-level logical flowchart of an exemplary process of managing the powering-down of prediction structures 304 in accordance with one or more embodiments. The illustrated process can be implemented, for example, by branch prediction unit 302 to update entries in regulator circuit 340. The process of FIG. 7 can be performed in parallel with the process of FIG. 6.

The process of FIG. 7 begins at block 700 and then proceeds to block 702, which illustrates branch prediction unit 302 monitoring for a completion event indicating completion of processing by prediction pipeline 332 of an index of a conditional branch instruction. In response to detection of the completion event, branch prediction unit 302 determines at block 704 whether or not a power-saving mode that enables one or more prediction structures 304 to be powered-down is currently inhibited for the index. In one embodiment, branch prediction unit 302 may make the determination depicted at block 704 by determining whether the entry in regulator circuit 340 corresponding to the index has a non-zero counter value. In response to a negative determination at block 704, the process passes to block 708, which is described below. If, however, branch prediction circuit 302 makes an affirmative determination at block 704, branch prediction unit 302 decrements the counter value in the entry of regulator circuit 340 corresponding to the index (block 706). The process then passes to block 708.

Block 708 illustrates branch prediction unit 302 determining whether or not a prediction structure subset changing (PSSC) event has occurred that impacts the accuracy of the power mode field of the current index. As noted above, one example of such a PSSC event is a line split event in which one or more additional conditional branch instructions are encountered in a given instruction cacheline and the additional conditional branch instruction(s) map to one or more additional subarrays 312 that have not been previously powered-on by the power mode field of the index. Detecting a PSSC event at block 708 enables branch prediction unit 302 to avoid use of a stale power mode field that may exist in latency accelerator 338 or LIB 334 due to the iterative operation of branch prediction unit 302 and thus to a branch misprediction and its concomitant performance penalty. In response to detection of a PSSC event at block 708, branch prediction unit 302 sets the entry associated with the current index to a predetermined maximum counter value that enforces a time window in which branch prediction unit 302 will power-up all prediction structures 304 when predicting conditional branch instructions corresponding to the index. By providing this time window after detection of the PSSC event, branch prediction unit 302 will complete a subsequent prediction for the index update the power mode field for the index prior to again using the power mode field to predict the appropriate power states of prediction structures 304. As will be appreciated, by providing this time window, branch prediction unit 302 also reduces reprediction events.

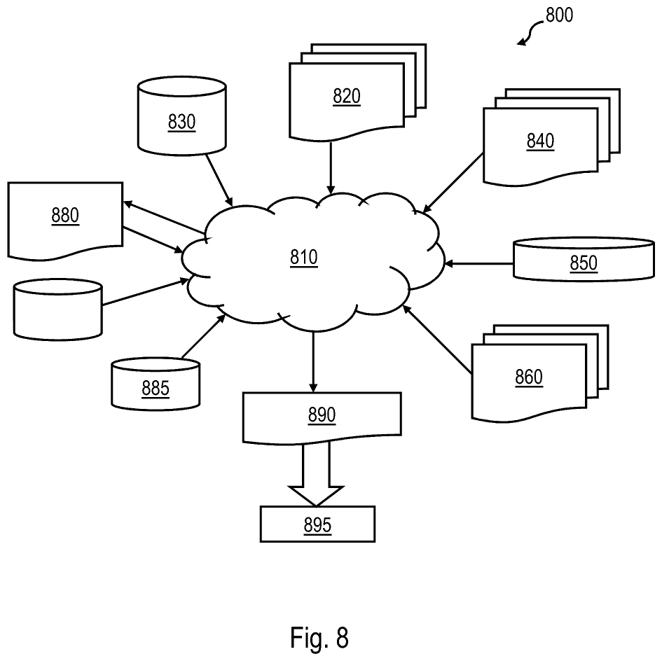

Referring now to FIG. 8, there is illustrated a block diagram of an exemplary design flow 800 used for example, in semiconductor IC logic design, simulation, test, layout, and manufacture. Design flow 800 includes processes, machines and/or mechanisms for processing design structures or devices to generate logically or otherwise functionally equivalent representations of the design structures and/or devices described above and shown herein. The design structures processed and/or generated by design flow 800 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 800 may vary depending on the type of representation being designed. For example, a design flow 800 for building an application specific IC (ASIC) may differ from a design flow 800 for designing a standard component or from a design flow 800 for instantiating the design into a programmable array, for example a programmable gate array (PGA) or a field programmable gate array (FPGA) offered by Altera® Inc. or Xilinx® Inc.

FIG. 8 illustrates multiple such design structures including an input design structure 1020 that is preferably processed by a design process 810. Design structure 820 may be a logical simulation design structure generated and processed by design process 810 to produce a logically equivalent functional representation of a hardware device. Design structure 820 may also or alternatively comprise data and/or program instructions that when processed by design process 810, generate a functional representation of the physical structure of a hardware device. Whether representing functional and/or structural design features, design structure 820 may be generated using electronic computer-aided design (ECAD) such as implemented by a core developer/designer. When encoded on a machine-readable data transmission, gate array, or storage medium, design structure 820 may be accessed and processed by one or more hardware and/or software modules within design process 810 to simulate or otherwise functionally represent an electronic component, circuit, electronic or logic module, apparatus, device, or system such as those shown herein. As such, design structure 820 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher-level design languages such as C or C++.

Design process 810 preferably employs and incorporates hardware and/or software modules for synthesizing, translating, or otherwise processing a design/simulation functional equivalent of the components, circuits, devices, or logic structures shown herein to generate a netlist 880 which may contain design structures such as design structure 820. Netlist 880 may comprise, for example, compiled or otherwise processed data structures representing a list of wires, discrete components, logic gates, control circuits, I/O devices, models, etc. that describes the connections to other elements and circuits in an integrated circuit design. Netlist 880 may be synthesized using an iterative process in which netlist 880 is resynthesized one or more times depending on design specifications and parameters for the device. As with other design structure types described herein, netlist 880 may be recorded on a machine-readable storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, or buffer space.

Design process 810 may include hardware and software modules for processing a variety of input data structure types including netlist 880. Such data structure types may reside, for example, within library elements 830 and include a set of commonly used elements, circuits, and devices, including models, layouts, and symbolic representations, for a given manufacturing technology (e.g., different technology nodes, 32 nm, 45 nm, 80 nm, etc.). The data structure types may further include design specifications 840, characterization data 850, verification data 860, design rules 890, and test data files 885 which may include input test patterns, output test results, and other testing information. Design process 810 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 810 without deviating from the scope and spirit of the invention. Design process 810 may also include modules for performing standard circuit design processes such as timing analysis, verification, design rule checking, place and route operations, etc.

Design process 810 employs and incorporates logic and physical design tools such as HDL compilers and simulation model build tools to process design structure 820 together with some or all of the depicted supporting data structures along with any additional mechanical design or data (if applicable), to generate a second design structure 890. Design structure 890 resides on a storage medium or programmable gate array in a data format used for the exchange of data of mechanical devices and structures (e.g., information stored in a IGES, DXF, Parasolid XT, JT, DRG, or any other suitable format for storing or rendering such mechanical design structures). Similar to design structure 820, design structure 890 preferably comprises one or more files, data structures, or other computer-encoded data or instructions that reside on transmission or data storage media and that when processed by an ECAD system generate a logically or otherwise functionally equivalent form of one or more of the embodiments of the invention shown herein. In one embodiment, design structure 890 may comprise a compiled, executable HDL simulation model that functionally simulates the devices shown herein.

Design structure 890 may also employ a data format used for the exchange of layout data of integrated circuits and/or symbolic data format (e.g., information stored in a GDSII (GDS2), GL1, OASIS, map files, or any other suitable format for storing such design data structures). Design structure 890 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown herein. Design structure 890 may then proceed to a stage 895 where, for example, design structure 890: proceeds to tape-out, is released to manufacturing, is released to a mask house, is sent to another design house, is sent back to the customer, etc.

As has been described, in at least one embodiment, a branch prediction unit of the processor powers-up and accesses only a subset of a plurality of prediction structures to obtain a first set of branch prediction information for a conditional branch. During the access, at least one of the plurality of prediction structures remains powered-down. The branch prediction unit thereafter determines whether all of the plurality of prediction structures having branch prediction information relevant to the conditional branch were accessed. Based on a determination that fewer than all of the plurality of prediction structures having branch prediction information relevant to the conditional branch were accessed, the branch prediction unit refrains from outputting a branch prediction based on the first set of branch prediction information, powers-up and accesses a greater number of the plurality of prediction structures to obtain a second set of branch prediction information, and outputs a branch prediction based on the second set of branch prediction information.

While various embodiments have been particularly shown and described, it will be understood by those skilled in the art that various changes in form and detail may be made therein without departing from the spirit and scope of the appended claims and these alternate implementations all fall within the scope of the appended claims.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The program product may include data and/or instructions that when executed or otherwise processed on a data processing system generate a logically, structurally, or otherwise functionally equivalent representation (including a simulation model) of hardware components, circuits, devices, or systems disclosed herein. Such data and/or instructions may include hardware-description language (HDL) design entities or other data structures conforming to and/or compatible with lower-level HDL design languages such as Verilog and VHDL, and/or higher-level design languages such as C or C++. Furthermore, the data and/or instructions may also employ a data format used for the exchange of layout data of integrated circuits and/or symbolic data format (e.g., information stored in a GDSII (GDS2), GL1, OASIS, map files, or any other suitable format for storing such design data structures).

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

1. A method of branch processing in a processor, the method comprising:
a branch prediction unit of the processor powering-up and accessing only a subset of a plurality of prediction structures to obtain a first set of branch prediction information for a conditional branch, wherein at least one of the plurality of prediction structures remains powered-down during the accessing, the branch prediction unit comprising a plurality of arrays storing branch prediction information, each array in the plurality of arrays being a prediction structure, an index pipeline including indices of instruction addresses of conditional branch instructions, a prediction pipeline configured to evaluate branch prediction information from accessed prediction structures, a line input buffer configured to buffer branch related information utilized by the prediction unit to access the prediction structures, a latency accelerator, wherein the latency accelerator is an array of entries configured to store indices of prediction structures and a power mode field configured to be utilized by the branch prediction unit to predict an appropriate power state of the prediction structures during a prediction access, and a regulator circuit configured to control powering down of the prediction structures;
thereafter, the branch prediction unit determining whether all of the plurality of prediction structures having branch prediction information relevant to the conditional branch were accessed; and
based on a determination that fewer than all of the plurality of prediction structures having branch prediction information relevant to the conditional branch were accessed:
the branch prediction unit refraining from outputting a branch prediction based on the first set of branch prediction information accessed from the subset of the plurality of prediction structures;
the branch prediction unit powering-up and accessing a greater number of the plurality of prediction structures to obtain a second set of branch prediction information; and
the branch prediction unit outputting a branch prediction based on the second set of branch prediction information; and
the branch prediction unit detecting a prediction structure subset changing (PSSC) event, wherein the PSSC event includes a line split event in which at least one addition conditional branch instruction is encountered in a given instruction cacheline and the at least one additional conditional branch instruction maps to one or more additional subarrays that have not been previously powered-on; and
based on detecting the PSSC event, powering-up and accessing all of the plurality of prediction structures for one or more branch predictions in a limited time window.

2. The method of claim 1, wherein:
the plurality of prediction structures include multiple branch target buffer subarrays; and
the subset of the plurality of prediction structures providing the first set of branch prediction information includes fewer than all of the branch target buffer subarrays.

3. The method of claim 1, wherein the greater number of the plurality of prediction structures comprises all of the plurality of prediction structures.

4. The method of claim 1, wherein:
the determining includes checking whether the first set of branch prediction information includes branch prediction information from each of the plurality of prediction structures for which the accessing resulted in a hit.

5. The method of claim 1, further comprising:
the branch prediction unit maintaining in association with the conditional branch a power mode field indicating the subset of a plurality of prediction structures; and
updating the power mode field based on the determining.

6. (canceled)

7. A processor comprising:
an instruction fetch unit configured to fetch instructions for processing;
a sequential instruction execution unit coupled to the instruction fetch unit, wherein the sequential instruction execution unit processes sequential instructions; and
a branch processing unit, coupled to the instruction fetch unit, for processing branch instructions, wherein the branch processing unit includes a branch prediction unit including a plurality of prediction structures for storing branch prediction information, and wherein the branch prediction unit is configured to perform, the branch prediction unit comprising a plurality of arrays storing branch prediction information, each array in the plurality of arrays being a prediction structure, an index pipeline including indices of instruction addresses of conditional branch instructions, a prediction pipeline configured to evaluate branch prediction information from accessed prediction structures, a line input buffer configured to buffer branch related information utilized by the prediction unit to access the prediction structures, a latency accelerator, wherein the latency accelerator is an array of entries configured to store indices of prediction structures and a power mode field configured to be utilized by the branch prediction unit to predict an appropriate power state of the prediction structures during a prediction access, and a regulator circuit configured to control powering down of the prediction structures:
powering-up and accessing only a subset of a plurality of prediction structures to obtain a first set of branch prediction information for a conditional branch, wherein at least one of the plurality of prediction structures remains powered-down during the accessing;
thereafter, determining whether all of the plurality of prediction structures having branch prediction information relevant to the conditional branch were accessed; and
based on a determination that fewer than all of the plurality of prediction structures having branch prediction information relevant to the conditional branch were accessed:
refraining from outputting a branch prediction based on the first set of branch prediction information accessed from the subset of the plurality of prediction structures;
powering-up and accessing a greater number of the plurality of prediction structures to obtain a second set of branch prediction information; and
outputting to the instruction fetch unit a branch prediction based on the second set of branch prediction information; and
the branch prediction unit detecting a prediction structure subset changing (PSSC) event, wherein the PSSC event includes a line split event in which at least one addition conditional branch instruction is encountered in a given instruction cacheline and the at least one additional conditional branch instruction maps to one or more additional subarrays that have not been previously powered-on; and
based on detecting the PSSC event, powering-up and accessing all of the plurality of prediction structures for one or more branch predictions in a limited time window.

8. The processor of claim 7, wherein:
the plurality of prediction structures include multiple branch target buffer subarrays; and
the subset of the plurality of prediction structures providing the first set of branch prediction information includes fewer than all of the branch target buffer subarrays.

9. The processor of claim 7, wherein the greater number of the plurality of prediction structures comprises all of the plurality of prediction structures.

10. The processor of claim 7, wherein:
the determining includes checking whether the first set of branch prediction information includes branch prediction information from each of the plurality of prediction structures for which the accessing resulted in a hit.

11. The processor of claim 7, wherein:
the branch prediction unit includes a latency accelerator array that maintains, in association with the conditional branch, a power mode field indicating the subset of a plurality of prediction structures; and
the branch prediction unit is configured to update the power mode field based on the determining.

12. (canceled)

13. A design structure tangibly embodied in a non-transitory machine-readable storage device for designing, manufacturing, or testing an integrated circuit, the design structure comprising:
a processor including:
an instruction fetch unit configured to fetch instructions for processing;
a sequential instruction execution unit coupled to the instruction fetch unit, wherein the sequential instruction execution unit processes sequential instructions; and
a branch processing unit, coupled to the instruction fetch unit, for processing branch instructions, wherein the branch processing unit includes a branch prediction unit including a plurality of prediction structures for storing branch prediction information, and wherein the branch prediction unit is configured to perform, the branch prediction unit comprising a plurality of arrays storing branch prediction information, each array in the plurality of arrays being a prediction structure, an index pipeline including indices of instruction addresses of conditional branch instructions, a prediction pipeline configured to evaluate branch prediction information from accessed prediction structures, a line input buffer configured to buffer branch related information utilized by the prediction unit to access the prediction structures, a latency accelerator, wherein the latency accelerator is an array of entries configured to store indices of prediction structures and a power mode field configured to be utilized by the branch prediction unit to predict an appropriate power state of the prediction structures during a prediction access, and a regulator circuit configured to control powering down of the prediction structures:
powering-up and accessing only a subset of a plurality of prediction structures to obtain a first set of branch prediction information for a conditional branch, wherein at least one of the plurality of prediction structures remains powered-down during the accessing;
thereafter, determining whether all of the plurality of prediction structures having branch prediction information relevant to the conditional branch were accessed; and
based on a determination that fewer than all of the plurality of prediction structures having branch prediction information relevant to the conditional branch were accessed:
refraining from outputting a branch prediction based on the first set of branch prediction information accessed from the subset of the plurality of prediction structures;
powering-up and accessing a greater number of the plurality of prediction structures to obtain a second set of branch prediction information; and
outputting to the instruction fetch unit a branch prediction based on the second set of branch prediction information; and
the branch prediction unit detecting a prediction structure subset changing (PSSC) event, wherein the PSSC event includes a line split event in which at least one addition conditional branch instruction is encountered in a given instruction cacheline and the at least one additional conditional branch instruction maps to one or more additional subarrays that have not been previously powered-on; and
based on detecting the PSSC event, powering-up and accessing all of the plurality of prediction structures for one or more branch predictions in a limited time window.

14. The design structure of claim 13, wherein:
the plurality of prediction structures include multiple branch target buffer subarrays; and
the subset of the plurality of prediction structures providing the first set of branch prediction information includes fewer than all of the branch target buffer subarrays.

15. The design structure of claim 13, wherein the greater number of the plurality of prediction structures comprises all of the plurality of prediction structures.

16. The design structure of claim 13, wherein:
the determining includes checking whether the first set of branch prediction information includes branch prediction information from each of the plurality of prediction structures for which the accessing resulted in a hit.

17. The design structure of claim 13, wherein:
the branch prediction unit includes a latency accelerator array that maintains, in association with the conditional branch, a power mode field indicating the subset of a plurality of prediction structures; and
the branch prediction unit is configured to update the power mode field based on the determining.

18. (canceled)
